(19) United States
(12) Patent Application Publication
(10) Pub. No.: US 2024/0373251 A1
(43) Pub. Date: Nov. 7, 2024

(54) MULTI-SERVICE RAN ARCHITECTURE

(71) Applicant: DISH WIRELESS L.L.C., ENGLEWOOD, CO (US)

(72) Inventors: David Zufall, Lone Tree, CO (US); Mehdi Alasti, Reston, VA (US); Siddhartha Chenumolu, Broadlands, VA (US)

(21) Appl. No.: 18/369,561

(22) Filed: Sep. 18, 2023

Related U.S. Application Data
(60) Provisional application No. 63/463,787, filed on May 3, 2023.

(51) Int. Cl. H04W 24/02

(52) U.S. Cl. CPC H04W 24/02

(57) ABSTRACT

An approach to adapt the topology of a disaggregated Radio Access Network (RAN) operating within a wireless network, depending on the attributes of a service to be supported by the RAN. The topology including a slice configuration for at least one of the disaggregated components of the RAN, including at least one Data Unit (DU), Central Unit (CU) or Control Unit (CU). Another resource, such as a compute or network resource may also be associated with topology. In some implementations, network connections between the resource and the disaggregated components of the RAN may be provided by a Virtual Local Area Network (VLAN).

### TECHNICAL FIELD

This patent relates to mobile wireless communication systems, and more particularly relates to techniques for optimizing the topologies used to deploy Radio Access Networks (RANs) based on the attributes of one or more services deployed by the system.

### BACKGROUND

The Third Generation Partnership Project (3GPP) Working Group Fifth Generation (5G) technology provides a broad range of wireless services that may be delivered across multiple access platforms and multi-layered networks supporting a variety of applications. 5G utilizes an intelligent architecture, with Radio Access Networks (RANs) not constrained by base station proximity or complex infrastructure.

5G technology has evolved to also include what is called a Service-Based Architecture (SBA), which implements Information Technology (IT) networking principles and cloud-native design approaches where possible. In this architecture, each Network Function (NF) can offer one or more interfaces to other NFs via Application Programming Interfaces (API). This architecture can be used to decouple software from hardware by replacing various functions such as location management, firewalls, load balancers and routers with virtualized instances running as software. This eliminates the need to invest in expensive hardware elements and can also accelerate installation times.

Network Functions enabling 5G infrastructure can also involve virtualizing appliances within the 5G network in certain ways. This can include network slicing technology that enables multiple virtual networks to run simultaneously. The concept extends to slicing of RAN components through, for example, network disaggregation promoted by alliances such as the Open RAN (O-RAN) Alliance. This enables flexibility, provides open interfaces and open source development, ultimately to ease the deployment of new features and technology with scale. The O-RAN Alliance objective is to allow multi-vendor deployment with off-the shelf hardware for the purposes of easier and faster inter-operability. Network disaggregation also allows these components to be virtualized, providing a means to scale and improve user experience as capacity grows. The benefits of virtualizing components of the RAN provide a means to be more cost effective from a hardware and software viewpoint especially for IoT applications where the number of devices is in the millions.

3GPP has also provided complete system level specifications for 5G network architectures which are much more service oriented than previous generations. 5G network slicing enables 5G mobile network operators (MNOs) to build and manage their network to meet and exceed the emerging requirements from a wide range of users or enterprises (i.e., tenants such as Virtual Mobile Network Operators (MVNOs)) sharing the same physical network resources of the MNO.

According to 5G standardization efforts, a 5G system should support the needs of users through the specification of several Key Performance Indicators (KPIs) such as data rate, traffic capacity, user density, latency, reliability, and availability. These capabilities may be specified based on a Service Level Agreement (SLA) between the mobile operator and their customer. These efforts have resulted in increased interest in mechanisms to ensure that services are delivered accurately and efficiently.

### SUMMARY OF PREFERRED EMBODIMENT(S)

This patent application describes a way to provide multiple topologies for deployment of a Radio Access Network (RAN), with the topologies based on the desired attributes of an offered service, such as latency, data rate, capacity, or the availability of associated resources such as compute resources.

More particularly, wireless communication is established between a disaggregated base station component known as a Radio Access Network (RAN) and one or more user equipment (UE) devices. Functions of the RAN are separated into a Radio Unit (RU) and one or more other units such as a Digital Unit (DU) and/or a Central Unit (CU). In one embodiment, the RU is mainly responsible implementing the lower parts of the physical layer of an air interface, with the DU and CU typically dedicated to the higher layers of the air interface. The DU and CU may be located many kilometers away from each other and their associated RU, with a Virtual Local Area Network (VLAN) connecting them together and open protocols used for communication.

The specific topology used to deploy the RAN may, for example, include a slice configuration for at least one of the disaggregated components of the RAN that depends on the service attributes.

In some implementations, the method also determines at least one other resource for the service depending on the attributes of the service. One or more network connections are then established between the at least one other resource and the disaggregated components of the RAN, thereby enabling the service.

When an appropriate topology for the disaggregated components of the RAN was previously determined, the approach may scale up or scale down a capacity of at least one of the disaggregated components of the RAN.

The attributes of the service may include one or more Key Performance Indicators (KPIs) selected from a group consisting of latency, capacity, data rate, user density, reliability, and availability.

The slice configuration may identify particular slices for one or more Central Unit Control Plane (CU-CP), Central Unit User Plane (CU-UP), Data Unit (DU), or Radio Unit (RU) disaggregated component.

The slice configuration may also further identify a particular location for at least one disaggregated component including a cell site, a Metropolitan Data Center (MDC) or Regional Data Center (RDC).

The location for the at least one disaggregated component may depend on one or more Key Performance Indicators (KPIs) for the service, such as latency, capacity, data rate, user density, reliability, or availability.

Further, in some embodiments, a given slice for a selected DU may be located at a cell site and associated with a topology for at least two different services, with a given slice for a selected CU-UP located at a data center remote from the cell site and associated with at least two different services. In that embodiment, the network connections may include a virtual network.

In some aspects, two or more services may be operated by the wireless network, with at least one service having different attributes than another one of the services. At least one of the disaggregated components of the RAN may be sliced into multiple slices, with each such slice associated with a different one of the two or more services.

Each slice may be allocated to a service provided for a different Mobile Network Virtual Operator (MNVO).

The at least one other resource may include an edge compute resource, Mobile Edge Compute (MEC), local core resource, or remote core resource.

### BRIEF DESCRIPTION OF THE DRAWINGS

Features and advantages of the approaches discussed herein are evident from the text that follows and the accompanying drawings, where:

FIG. 1 is an example wireless network with a disaggregated Radio Access Network (RAN).

FIG. 2 shows how the attributes of a service can be used to determine a topology for a RAN.

FIG. 3 is an example RAN topology for a first service.

FIG. 4 is an example of a RAN topology for second service.

FIG. 5 is an example of a RAN topology for a third service.

FIG. 6 has an example of RAN slice topology for a fourth service.

FIG. 7 illustrates an example where these four services are all deployed at the same time.

FIG. 8 is an example of a process flow that may be executed by an orchestrator to instantiate a RAN topology depending on the performance indicators of a service.

FIG. 9 shows a system diagram that describes an example implementation of underlying data processing system(s) for implementing the embodiments described herein.

### DETAILED DESCRIPTION OF PREFERRED EMBODIMENT(S)

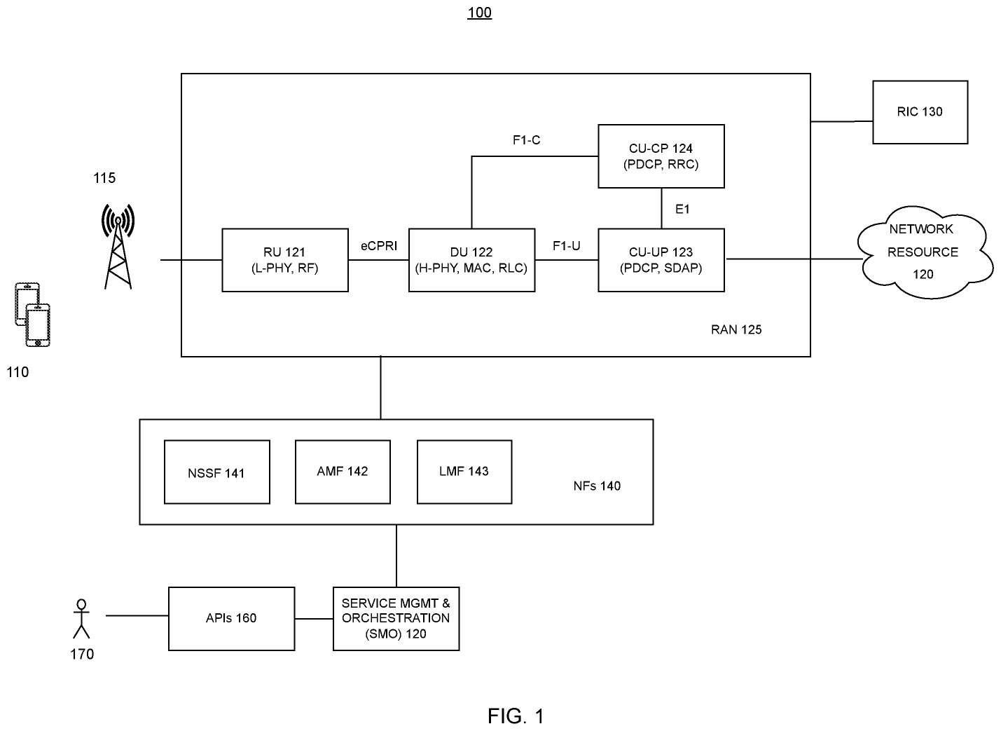

FIG. 1 is a block diagram of an example wireless communication system 100 that optimizes Radio Access Network (RAN) topologies based on the scope of a desired service.

The illustrated system 100 uses a RAN 125 that provides the functions of a 3GPP Evolved Node B (eNB) or Next Generation Node B (gNB) base station, disaggregating these functions into a Radio Intelligent Controller (RIC) 130, and Central Unit (CU) split into a Control Plane (CU-CP) 124 and a User Plane (CU-UP) 123, a Data Unit (DU) 122, and a Radio Unit (RU) 121. These components collectively provide connectivity from User Equipment 110 to other network resources 120.

These components may operate according to a 3GPP-compliant New Radio (NR) protocols such as Open RAN. The components can be controlled together or independently and can be deployed on either physical machines (e.g. a small cell hardware) or as virtual machines running on dedicated servers or shared cloud resources or some combination thereof.

The RIC 130 is a logical node that enables near-real-time and non-real-time control, optimization of RAN 125 elements and resources, model training, updates, and other functions. The RIC 130 may optimize control of the elements of the RAN 125 and its resources, based on the data collected from RU 121, DU 122, CU-UP 123, CU-CP 124, etc. through various interfaces.

The CU functions, including the CU-CP 124 and the CU-UP 123, as a logical node that provides the functions of Radio Resource Control (RRC), Service Data Adaptation Protocol (SDAP), and Packet Data Convergence Protocol (PDCP). The CU-CP 124 in particular is a logical node that provides functions of the control plane portion of the RRC and PDCP, whereas the CU-UP 123 is a logical node that provides functions of a user plane portion of SDAP and PDCP.

The CU-CP 124 connects to other functions such as an Access and Mobility Management Function (AMF) 142, Location Management Function (LMF) 143 and other Network Functions (NFs) 140 to provide a 5G network core. These connections may be through a Next Generation (NG) Application Protocol (NGAP) or other interfaces.

The DU 122 is a logical node that provides Radio Link Control (RLC), Media Access Control (MAC), and higher physical layer (high-PHY) functions. Multiple RUs 121 may communicate with a single DU 122. The DU 122 functions as a logical node of the cellular network between RUs 121 and CUs 123, 124. Notably, the multiple RUs 121 that may communicate with a single DU 122 may be made by different manufacturers. If the base station operates according to 5G RAN protocols, the cellular network can tolerate different make/model of RUs 121; therefore, a secondary operator is not restricted to using a particular make/model of RU 121 or DU 122.

The RU 121 serves as the lower physical layer of the air interface between the cellular network User Equipment (UEs) 110. RU 121 handles transmitting and receiving data and/or voice according to a particular wireless communication protocol, such as 3G, 4G LTE, 5G NR, or some future technology, such as 6G or beyond. The RU 121 is connected to one or more antennas 115 that may be located on a tower.

UEs 110 represent various forms of mobile wireless devices that can communicate using the cellular network. For example, mobile phones, smartphones, cellular modems, personal computers, wireless sensors, access points (APs), gaming devices, Internet of Things (IoT) devices, and any other 5G-equipped device may function as UEs 121.

CUs 123, 124 may reach various other network resources 120, such as the Internet and/or some other public or private network. In other embodiments, such network resources 120 may also be accessible directly by CUs 123, 124, and/or by DUs 122.

FIG. 1 shows each logical node with a singular number, but in many instances each logical node is connected in plural. For example, a number of RUs 121 may be connected to one DU 122, and a number of DUs 122 may be connected to one CU-UP 123. Also, any given RU 121 may be communicating with many UEs 110.

In some implementations, the Radio Intelligent Controller (RIC) 130 may be split onto Non-Real Time RIC (Non-RT RIC) and Near-RT RIC functions (not shown in FIG. 1) Non-RT RIC functions provide configuration management, analytics, obtains A1 interface-based feeds, and provides the recommendations to Near-RT RIC over the A1 interface. Its general task is to support non-real-time optimization of the network and procedures. The A1 interface is used to provide policies, enrichment information, Machine Learning (ML) model management towards the Near-RT RIC, and provides policy feedback to the Non-RT RIC.

The 3GPP working group also defines a Service-Based Architecture (SBA), whereby the control plane functionality and common data repositories of a 5G network may be delivered by way of a set of interconnected Network Functions (NFs) 140 implemented in a 5G core, each with authorization to access each other's services.

The 5G SBA NFs 140 may include numerous components, including: the aforementioned AMF 142 and LMF 143 as well as many other control plane functions including network resource management, signaling, packet control, policy, location services, subscriber management, and other functions not shown here.

Assuming the role of either service consumer or service producer, Network Functions 140 are self-contained, independent and reusable. Each Network Function 140 exposes its functionality through an Application Programming Interface (API) 160, which may be a Service Based Interface (SBI). In one example, the API 160 may employ a REST interface using HTTP/2 or other protocols such as a Quick UDP Internet Connection (QUIC) protocol.

The APIs 160 provides a way for an administrative user to specify services configuration details to a Service Management and Orchestration (SMO) component 155 that further interfaces to the Network Functions 140.

Of interested here is a NSSF (Network Slicing Selection Function) part of the NFs 140. NSSF provides one way for the SMO 155 to select an optimal network slice configuration available to deploy a particular service from multiple services that are provided by the system 100.

Network slicing enables the multiplexing of virtualized and independent logical networks on the same physical network infrastructure. Each network slice provides an isolated end-to-end platform tailored to fulfil the requirements of a particular service.

In one example, the infrastructure provider (such as an owner of the illustrated network 100) leases these resources as a service to multiple Mobile Virtual Network Operators (MVNOs) that share the underlying physical network. In one example use case, each network slice is administrated by a given MVNO. According to the availability of the assigned resources, a MVNO can autonomously deploy multiple network slices that are customized to the various applications provided to that MVNO's own users.

Of particular interest here is that the components of the RAN 125 can be sliced, thus allowing different network operators to share the individual components of the RAN 125 as common resources.

In particular, the basic idea of RAN slicing is to “split” the components of the RAN 125, including one or more of the RU 121, DU 122, CU-UP 123 and CU-CP 124, into multiple logical and independent components. The RAN components may then be deployed in the system 100 configured to effectively meet the varied requirements of different network operators.

To quantitatively realize such concept, the SMO 155 or some other orchestration element to coordinate the different RAN components that are involved in the life-cycle of each network slice. The SMO also manages connections between them, such as via a Virtual Local Area Network (VLAN) or in other ways. In this context, the SMO 155 enable a dynamic and flexible configuration of the RAN slices.

Slicing thus allows a network operator to deploy specific services or applications that cater to particular clients and use cases. Certain applications—such as mobile gaming, video streaming, machine-to-machine communications (e.g. in manufacturing or logistics), or smart vehicles—can benefit from leveraging different aspects of 5G technology in different ways. One such service might require higher speeds, but another service might prefer low latency. Yet another service might require access to a speed-optimized edge computing resource. Thus, by creating separate RAN slices and other network resources that prioritize specific features, a network operator can offer differentiated solutions tailored to particular use cases.

For example, the network operator may offer different service types such eMBB (enhanced Mobile Broadband), URLLC (Ultra Reliable Low Latency Communications), mMTC (massive Machine Type Communications), Industrial Internet of Things (IIoT) and/or a Vehicle to Everything (V2X) service all using the same RAN 125 infrastructure. Each such service may have distinct requirements for data rates, reliability, latency, bandwidth and other Key Performance Indicators (KPIs).

For example, the user of a Mobile IoT service intended to collect data from electric power metering devices in a particular rural area may be able to tolerate high latency and may only need very narrow bandwidth. That type of user may benefit from a first configuration of the RAN 125 where the DU 122 and CUs 123, 124 may be remote from the site of the RU and shared with other services. However, the users of a V2X service intended for self-driving vehicles may require low latency, high reliability so that the DU 122 and CUs 123, 124 are located closer to the RU 121 and have redundancy, and can access compute resources located at a network 120 edge. Therefore, the V2X service may benefit from different Key Performance Indicators (KPIs) and a different RAN configuration than the MIoT service. Deployment of a mobile virtual reality gaming application may require eMBB (Enhanced Mobile Broadband) technology to deliver ultra-high bandwidth for video streaming, and lowest possible latency to provide an immersive Virtual Reality (VR) experience. This service may need fully dedicated RAN 125 and network resources 120.

Although FIG. 1 suggests that APIs 160 are accessed by administrative users 170 to configure the system 100, it should be understood that there are other ways to specify how the RAN 125 components are to be configured based on Key Performance Indicators (KPIs) or other attributes of a given service.

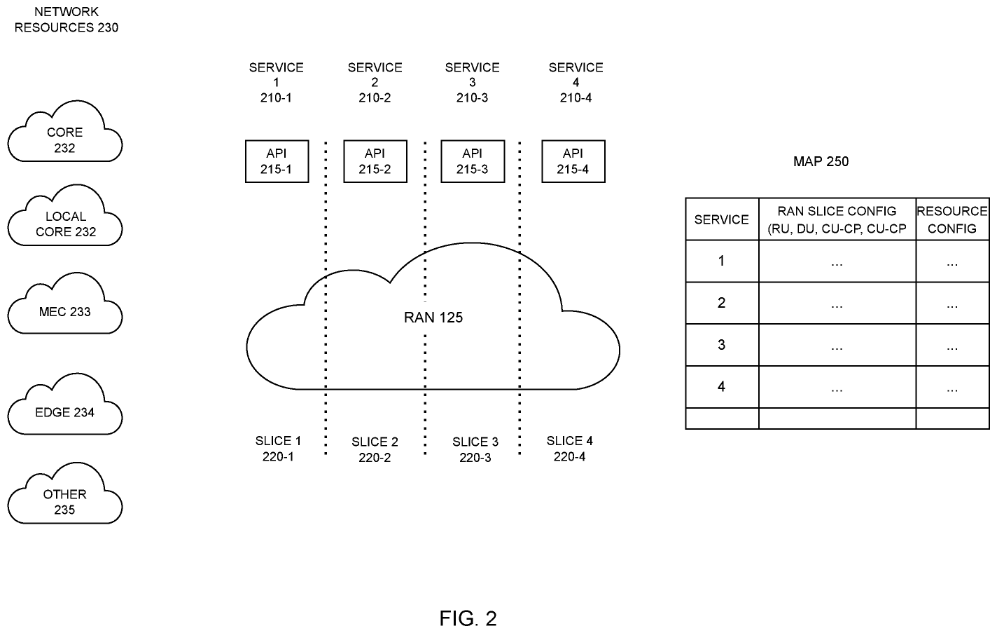

FIG. 2 is a logical view of how different services may be assigned to different RAN slice topologies and other resources.

Recall that the disaggregated component model enables different scenarios, and different combinations of the disaggregated components of the RAN 125. For example, in a low latency service, the RU 121, DU 122 and CUs 123, 124 DU can all be located at the cell cite location adjacent the tower 115. The particular model or configuration of RU 121, DU 122 and CUs 123, 124 and RU should also support low latency services such as Mobile Edge Compute (MEC).

However for other services that can tolerate higher latency, the CUs 123, 124 and/or DU 122 may be deployed in some other location, away from the RU 121, with these components connected in a VLAN. Thus, the RAN 125 components should not only be appropriate for the desired set of features, but should also be deployed in a topology that is optimized for that service.

The SMO 155 thus coordinates with the RIC 130 (both the non-real-time RIC and near-real-time RIC) to deploy an appropriate RAN topology depending on the requirements of the service.

Other than latency, RAN 125 topology and network configurations may be optimized on other attributes such as type and size of cell (urban, suburban, rural, cell area), data rates and data types (voice and/or data only), jitter, throughput, maximum number of connections, other network resources (local or remote core, edge computing, or access to a particular data processing application such as Artificial Intelligence (AI), etc.). Any or all of these may be specified as one or more Key Performance Indicators (KPIs) associated with each service.

FIG. 2 is thus a logical view of the services 210 that a particular system 100 may support, including a first service 2101, second service 210-2, third service 210-3, fourth service 210-4 and so on. Each service can be accessed through a respective Application Programming Interface (API) 215-1, 215-2, 21503, 215-4, which in turns may be used to define an appropriate topology specific to that service. Each service also accesses a respective slice of the disaggregated components of the RAN 125, which includes corresponding slices 220-1, 220-2, 220-3, 220-4.

The idea is that there are different instances of RAN slices, including RUs 121 DUs 122, and CUs 123, 124 each supporting different features and capabilities appropriate for the associated service 210 and where these components will be located.

In one embodiment, a map 250 is maintained such as by the SMO 155 to enable matching appropriate RAN topologies to service requirements. The map 250 associates a slice 210 (or a group of slices) with a particular configuration for RUs, DUs, and CUs. The DUs and CUs may be selected based on the capacity needed for that service. Thus individual DUs and CUs may be scaled up or down as needed. For example, a single RU may be connected to multiple different DUs.

In addition, other aspects of that topology, such as VLAN or VRF configuration, is also specified by the map 250.

The map may also be used to determine other resources needed by the service, such as other network resources 230. These other resources may include a 5G core 231, or a local core 232, an Mobile Edge Compute (MEC) 233, other edge compute resource 234 or other data processing resource 235.

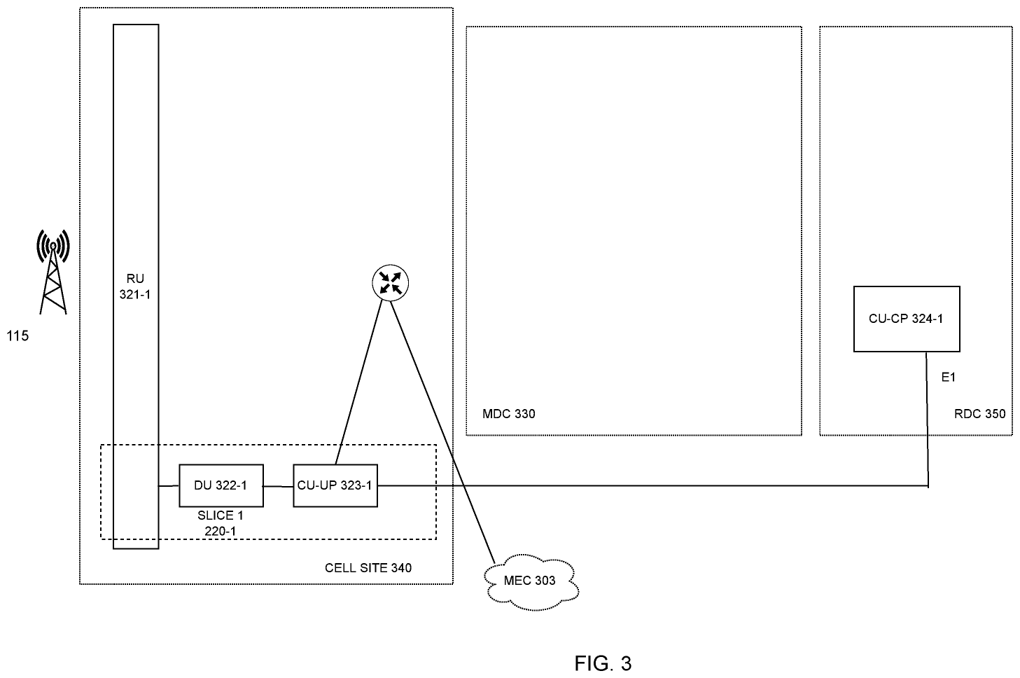

FIG. 3 is a first example of how RAN and core resources may be configured based on the attributes of a service. In this example, the provider of network 100 has an option to deploy components of the RAN 125 to different data center locations which may include a cell site 340, Metropolitan Data Center (MDC) 330, and Regional Data Center 340. These data centers may be located progressively further away from the tower 115.

In this first use case (slice 1 220-1) the RU 321-1, DU 322-1, and CU-UP 323-1 are deployed at the cell site 320. A CU-CP component is located in the RDC 340 and connected to the CU-UP 323-1 via an E1 interface.

Network infrastructure, such as a router 335-1 provides a connection to a Mobile Edge Compute (MEC) resource 333. The MEC 333 (also known as a Multi-access Edge Compute), combines elements of both physical and cloud computing to provide a software framework at the edges of a 5G network. Deploying a MEC 333 in this way may be desirable for a service that requires minimal end-to-end latency, such as a V2V service deployed to control autonomous vehicles.

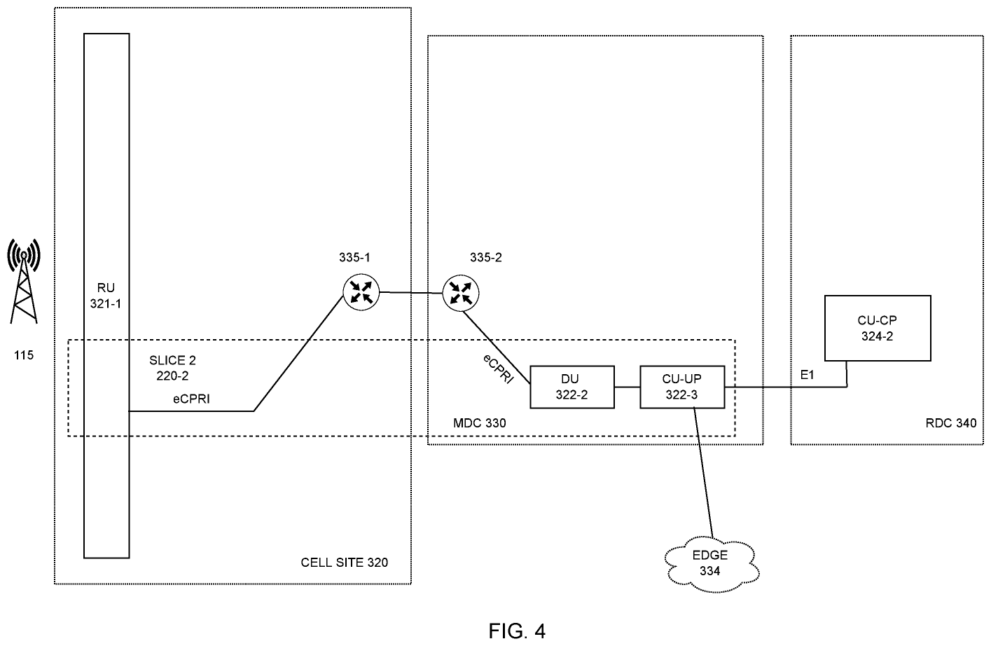

FIG. 4 is an example of a RAN topology for another service supported by slice 2 220-2. Here the DU 322-2 and CU 323-2 are instantiated at the MDC 330 and connected to an edge network 334 resource. The RU slice 321-2 is still located at the cell cite 320. Connectivity (such as via an eCPRI protocol) is provided through a pair of routers 335-1, 335-2, however a different VLAN is used than was used for slice 1 (compare to FIG. 3). If the routers 335 have a layering function, then a Virtual Routing and Forwarding (VRF) instance or some other logical group of network devices can be used to provide connectivity.

It should be understood that there may be still other routers or switches between the CU-UP 323-2 and the edge 334, and that other technologies may be used to connect the disaggregated components of the RAN 125.

The deployment of FIG. 4 may be suitable for a service that can tolerate some level of latency.

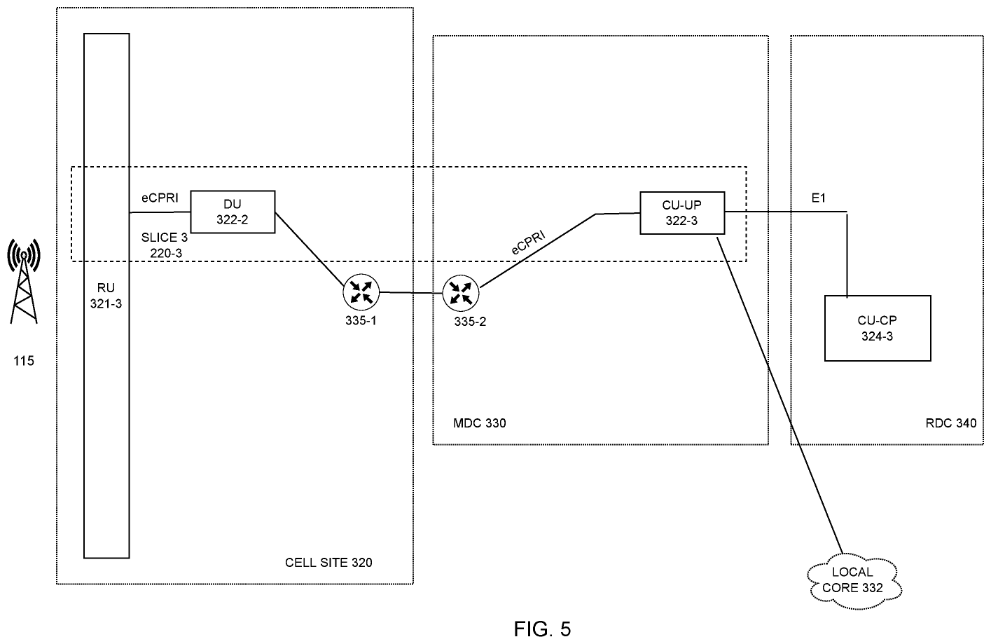

FIG. 5 is an example of third service 210-3 implemented with yet another topology 220-3 for the RAN slices. Here a DU slice 322-3 is instantiated at the cell site 320, but the CU-UP 323-3 is instantiated at the MDC 330, some distance away from the cell cite. Connectivity is provided to a local core 332 accessible at the MDC 330. This service 210-3 might provide Ultra Reliable Low Latency Connection (URLLC), such as used to control robots deployed in a factory. This end use may need a low latency physical layer, thus dictating the need to place the DU 322-3 close to the RU 321-3, but may not need low latency for the control functions implemented in the CU-CP 323-3, which can be located further away at the MDC 330.

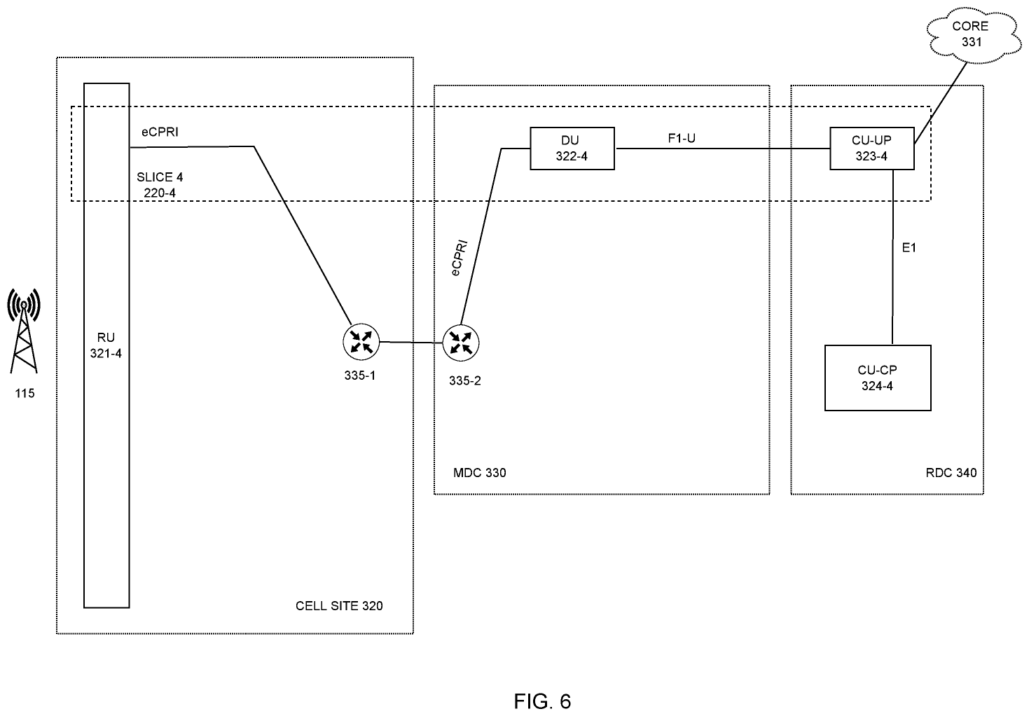

FIG. 6 has an example of RAN slice topology 220-4 for a fourth service 210-4. Here the RU remains at the cell site 320, but the DU 322-4 is now placed in the MDC 330. The CU-CP is located in the RDC 340. The connectivity will again be different, with the routers 335-1, 335-2 configured in appropriate VLAN and with the appropriate interfaces. Note, for example, the use of an F1-U interface between the DU 322-4 and CU-UP 323-4 which is now located remotely from the DU 322-4.

A core network 331 located at the RDC 340 may be the preference for this service 220-4. This service 220-4 may thus be deployed for example, to enable Mobile Internet of Things (MIoT) where low data rates and low and high latency can be tolerated.

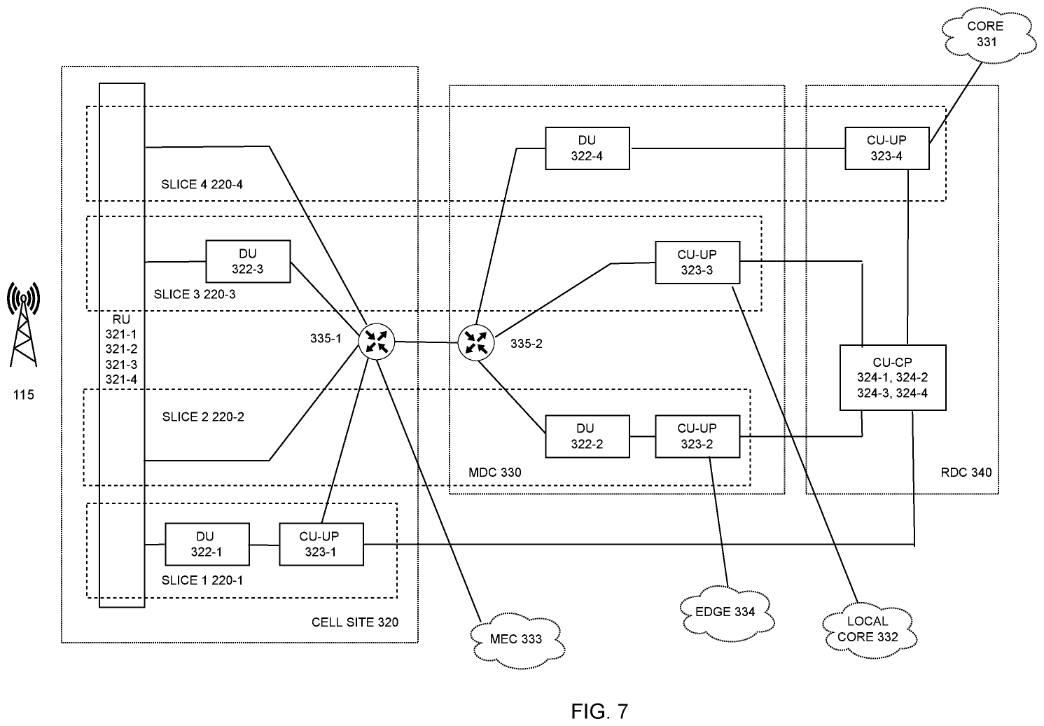

FIG. 7 illustrates an example where these four services 220-1, 220-2, 220-3, 220-4 are all deployed at the same time. Note that all in this example, four services utilize a single sliced RU 321 as well as a single sliced CU-CP 324.

A sliced DU 322 at the cell cite support services 210-1 and 210-3 simultaneously, a single sliced DU 322 deployed at the MDC 330 supports service 2 and service 4 simultaneously, and a sliced CU-UP 323 deployed at the MDC 330 supports both service 2 and service 3 simultaneously.

It should now be understood that the SMO 155 may be placed at the RDC 340 or any convenient location to orchestrate the RAN topology and other compute resources for any given service.

The service-oriented orchestration provided by SMO 155 can determine an optimal place for the disaggregated DUs 322 and CUs 323, 324, as well as the appropriate dimensioning and capacity for these disaggregated components. The SMO 155 may coordinate with the RIC 130 to enable appropriate dimensioning and capacity for these components, as well as the connections between them, such as a VLAN. As explained above, the orchestrator 155 may use a table such as shown in FIG. 2 to determine these configuration parameters.

In short, given a request for a service, then based on that request, the SMO 155 can select a RAN topology tailored to the service, a capacity dimension for that service, and one or more areas in which that service is to be offered. This service-oriented RAN deployment then instantiates the disaggregated RAN functions (e.g., an RU, DU, and CU-UP and CU-CP) in a located tailored for the service, as well as any other networking functions that matches the service's requirements.

In an instance where the appropriate RAN 125 topology already exists, instead of deploying new slice(s), the SMO 155 can just scale up that existing RAN 125 topology.

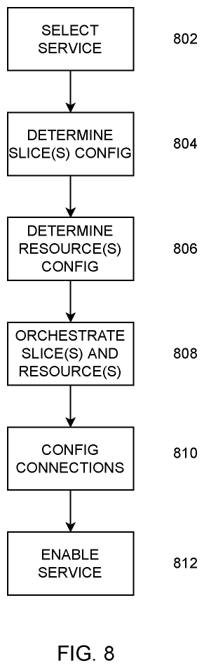

FIG. 8 is an example of a process flow 800 that may be executed by the SMO 155 to instantiate a RAN topology depending on the performance indicators of a service.

In state 802, a service to be deployed by the system 100 is first identified.

Next in state 804, a RAN slice topology for the service is determined. This may include performing a table 250 lookup as was described in FIG. 2. The RAN slice topology may specify one or more RUs 321, DUs 322, CU-UPs 323 and CU-UPs 324 to be deployed for the service, as well as a location for each such component (such as at one or more cell sites 340, MDCs 330 or RDCs 350). In addition, an attribute needed for each component matching the KPIs for the service (such as its latency or bandwidth, etc.) may factor into which RAN components are selected and their location.

State 806 determines, such as from the table 250, one or more configurations for other resources needed by the service, such as a network resource 120. The selected service 230 may depend on attributes of the needed resource, such as its KPIs.

State 808 then instantiates the selected RAN slice 125 topology and resources 120.

State 810 may then determine network connections for the instantiated RAN slices 125 and resources 120, such as by configuring a VLAN to connect them.

In state 812 the RAN 125 and associated resource(s) 120 may now be enabled for access by the service.

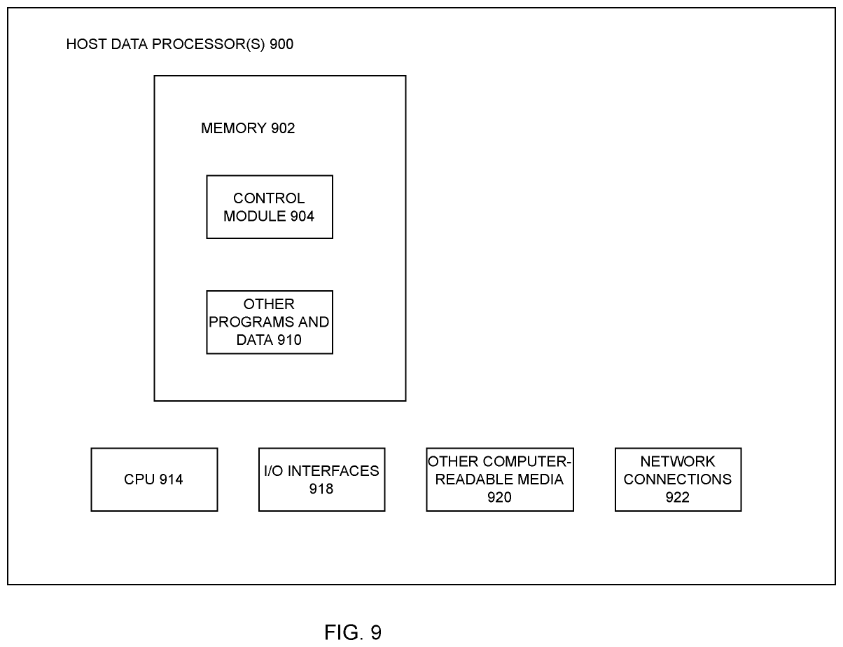

FIG. 9 shows a system diagram that describes an example implementation of underlying data processing system(s) 901 for implementing embodiments described herein.

The functionality described herein for implementing services-based network slicing in a wireless network can be implemented either on dedicated hardware, as a software instance running on dedicated hardware, or as a virtualized function instantiated on an appropriate platform, e.g., a cloud infrastructure. In some embodiments, such functionality may be completely software-based and designed as cloud-native, meaning that they are agnostic to the underlying cloud infrastructure, allowing higher deployment agility and flexibility. However, FIG. 9 illustrates an example of underlying hardware on which such software and functionality may be hosted and/or implemented.

In particular, shown is example host computer system(s) 900. For example, such computer system(s) 900 may represent one or more of those in various data centers, base stations and cell sites shown and/or described herein that are, or that host or implement the functions of: routers, components, microservices, containers, nodes, node groups, control planes, clusters, virtual machines, network functions, and other aspects described herein for services-based Radio Access Network (RAN) slicing for in a wireless telecommunication network. In some embodiments, one or more special-purpose computing systems may be used to implement the functionality described herein. Accordingly, various embodiments described herein may be implemented in software, hardware, firmware, or in some combination thereof. Host computer system(s) 900 may include memory 902, one or more central processing units (CPUs) 914, I/Interfaces 918, other computer-readable media 920, and network connections 922.

Memory 902 may include one or more various types of non-volatile and/or volatile storage technologies. Examples of memory 902 may include, but are not limited to, flash memory, hard disk drives, optical drives, solid-state drives, various types of random access memory (RAM), various types of read-only memory (ROM), neural networks, other computer-readable storage media (also referred to as processor-readable storage media), or the like, or any combination thereof. Memory 902 may be utilized to store information, including computer-readable instructions that are utilized by CPU 914 to perform actions, including those of embodiments described herein.

Memory 902 may have stored thereon control module(s) 904. The control module(s) 904 may be configured to implement and/or perform some or all of the functions of the systems, components and modules described herein for services-based Radio Access Network slicing in a wireless telecommunication network. Memory 902 may also store other programs and data 910, which may include rules, databases, application programming interfaces (APIs), policy and charging rules and data, OSS data, BSS data, software containers, nodes, pods, clusters, node groups, control planes, software defined data centers (SDDCs), microservices, virtualized environments, software platforms, cloud computing service software, network management software, network orchestrator software, one or more network slicing controllers, network functions (NF), artificial intelligence (AI) or machine learning (ML) programs or models to perform the functionality described herein, user interfaces, operating systems, other network management functions, other network functions (NFs), etc.

Network connections 922 are configured to communicate with other computing devices to facilitate the functionality described herein. In various embodiments, the network connections 922 include transmitters and receivers (not illustrated), cellular telecommunication network equipment and interfaces, and/or other computer network equipment and interfaces to send and receive data as described herein, such as to send and receive instructions, commands and data to implement the processes described herein. I/Interfaces 918 may include user data interfaces, sensor data interfaces, other data input or output interfaces, or the like. Other computer-readable media 920 may include other types of stationary or removable computer-readable media, such as removable flash drives, Solid State Drives (SSDs), external hard drives, or the like.

### Further Implementation Options

The disclosure is also not limited by the name of each node described above, and in the case of a logical node or entity performing the above-described function, the configuration of the disclosure may be applied. In addition, the different logical nodes may be physically located in the same or different physical location as other logical nodes, and may be provided with a function by the same physical device (e.g., a processor, a controller, etc.) or by another physical device. As an example, the function of at least one logical node described herein may be provided through virtualization in one physical device.

The methods, systems, and devices discussed above should be considered to be examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional states or steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may then execute the program code to perform the described tasks.

It should be understood that the workflow of the example embodiments described above may be implemented in many different ways. In some instances, the various “data processors” may each be implemented by a physical or virtual or cloud-based general purpose computer having a central processor, memory, disk or other mass storage, communication interface(s), input/output (I/O) device(s), and other peripherals. The general-purpose computer is transformed into the processors and executes the processes described above, for example, by loading software instructions into the processor, and then causing execution of the instructions to carry out the functions described.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read only memory (ROM); random access memory (RAM); storage including magnetic disk storage media; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc.

It also should be understood that the block and system diagrams may include more or fewer elements, be arranged differently, or be represented differently. But it further should be understood that certain implementations may dictate the block and network diagrams and the number of block and network diagrams illustrating the execution of the embodiments be implemented in a particular way.

Embodiments may also leverage cloud data processing services such as Amazon Web Services, Google Cloud Platform, and similar tools.

Accordingly, further embodiments may also be implemented in a variety of computer architectures, physical, virtual, cloud computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A method for operating a service in a wireless network, comprising:
identifying attributes of the service;
determining a topology for disaggregated components of a Radio Access Network (RAN), the topology depending on the attributes of the service, the topology including a slice configuration for at least one of the disaggregated components of the RAN;
determining at least one other resource for the service depending on the attributes of the service;
establishing one or more network connections between the at least one other resource and the disaggregated components of the RAN; and
enabling the service for access by User Equipment (UE).

2. The method of claim 1 additionally comprising:
when a topology for the disaggregated components of the RAN was previously determined, scaling up or down a capacity of at least one of the disaggregated components of the RAN.

3. The method of claim 1 wherein the attributes of the service comprise one or more Key Performance Indicators (KPIs) selected from a group consisting of latency, capacity, data rate, user density, reliability, and availability.

4. The method of claim 1 wherein the slice configuration identifies a particular slice for one or more Central Unit Control Plane (CU-CP), Central Unit User Plane (CU-UP), Data Unit (DU), or Radio Unit (RU) disaggregated component.

5. The method of claim 4 wherein the slice configuration further identifies a particular location for at least one disaggregated component including a cell site, a Metropolitan Data Center (MDC) or Regional Data Center (RDC).

6. The method of claim 5 wherein the particular location for the at least one disaggregated component depends on one or more Key Performance Indicators (KPIs) for the service, the one or more KPIs selected from a group consisting of latency, capacity, data rate, user density, reliability, and availability.

7. The method of claim 4 and further wherein:
a given slice for a selected DU is located at a cell site and associated with a topology for at least two different services;
a given slice for a selected CU-UP is located at a data center remote from the cell site and associated with at least two different services; and
the one or more network connections include a virtual network.

8. The method of claim 1 further wherein:
two or more services are operated by the wireless network, with at least one service having different attributes than another one of the services; and
at least one of the disaggregated components of the RAN are sliced into multiple slices, with each such slice associated with a different one of the two or more services.

9. The method of claim 8 wherein each slice is allocated to a service provided for a different Mobile Network Virtual Operator (MNVO).

10. The method of claim 1 wherein the at least one other resource is selected from a group consisting of an edge compute resource, Mobile Edge Compute (MEC), local core resource, and remote core resource.

11. An apparatus for operating a service in a wireless network, wherein the wireless network utilizes disaggregated components for a Radio Access Network (RAN), the apparatus comprising:
one or more data processors; and
one or more computer readable media including instructions that, when executed by the one or more data processors, cause the one or more data processors to perform a process for:
identifying attributes of the service;
determining a topology for the disaggregated components of the (RAN), the topology depending on the attributes of the service, the topology further including a slice configuration for at least one of the disaggregated components of the RAN;
determining at least one other resource for the service depending on the attributes of the service;
establishing one or more network connections between the at least one other resource and the disaggregated components of the RAN; and
enabling the service for access by User Equipment (UE).

12. The apparatus of claim 11 additionally comprising:
when a topology for the disaggregated components of the RAN was previously determined, scaling up or down a capacity of at least one of the disaggregated components of the RAN.

13. The apparatus of claim 11 wherein the attributes of the service comprise one or more Key Performance Indicators (KPIs) selected from a group consisting of latency, capacity, data rate, user density, reliability, and availability.

14. The apparatus of claim 11 wherein the slice configuration identifies a particular slices for one or more Central Unit Control Plane (CU-CP), Central Unit User Plane (CU-UP), Data Unit (DU), or Radio Unit (RU) disaggregated component.

15. The apparatus of claim 14 wherein the slice configuration further identifies a particular location for at least one disaggregated component including a cell site, a Metropolitan Data Center (MDC) or Regional Data Center (RDC).

16. The apparatus of claim 15 wherein the particular location for the at least one disaggregated component depends on one or more Key Performance Indicators (KPIs) for the service, the one or more KPIs selected from a group consisting of latency, capacity, data rate, user density, reliability, and availability.

17. The apparatus of claim 14 and further wherein:
a given slice for a selected DU is located at a cell site and associated with a topology for at least two different services;
a given slice for a selected CU-UP is located at a data center remote from the cell site and associated with at least two different services; and
the one or more network connections include a virtual network.

18. The apparatus of claim 11 further wherein:
two or more services are operated by the wireless network, with at least one service having different attributes than another one of the services; and
at least one of the disaggregated components of the RAN are sliced into multiple slices, with each such slice associated with a different one of the two or more services.

19. The apparatus of claim 18 wherein each slice is allocated to a service provided for a different Mobile Network Virtual Operator (MNVO).

20. The apparatus of claim 11 wherein the at least one other resource is selected from a group consisting of an edge compute resource, Mobile Edge Compute (MEC), local core resource, and remote core resource.
